(19) United States
(12) Patent Application Publication
(10) Pub. No.: US 2015/0377451 A1
(43) Pub. Date: Dec. 31, 2015

(54) LIGHT REDIRECTING FILM AND WIDE-VIEWING ANGLE LCD COMPRISING THE SAME

(71) Applicant: TAIWAN KANGDEXIN COMPOSITE MATERIAL CO., LTD., HSINCHU CITY (TW)

(72) Inventors: PO-HUNG YAO, HSINCHU CITY (TW); WEN-HSUN YANG, HSINCHU CITY (TW)

(21) Appl. No.: 14/742,796

(22) Filed: Jun. 18, 2015

(30) Foreign Application Priority Data
Jun. 27, 2014 (TW) 103211429

(51) Int. Cl. F21V 5/02; G02F 1/1335

(52) U.S. Cl. CPC F21V 5/02; G02F 1/133526

(57) ABSTRACT

Provided are a light redirecting film and a wide-viewing angle liquid crystal display. The light redirecting film has a transparent substrate and multiple microstructure units, the transparent substrate has first and second optical surfaces, and the microstructure units are formed on the second optical surface and spaced apart from each other in an areal percentage ranging from 8% to 60%. Accordingly, the light redirecting film is effective to redirect the output light of the LCD module and thus enhances the luminance of the LCD at large viewing angles.

### CROSS-REFERENCE TO RELATED APPLICATION

The present invention claims the priority of Taiwan Patent Application No. 103211429 filed on Jun. 27, 2014, which is incorporated by reference in the present application in its entirety.

### BACKGROUND OF THE INVENTION

1. Field of the Invention

The present invention relates to display technology field, more particularly to a light redirecting film and a wide-viewing angle liquid crystal display (wide-viewing angle LCD) comprising the same.

2. Description of the Prior Arts

Thin film transistor liquid crystal displays, TFT-LCDs, typically utilize rotations of liquid crystal molecules to cause polarization of the incident light. When an output polarizing plate is applied to the TFT-LCD, such TFT-LCD often has the problem of narrow viewing angle, and thus the luminance, contrast, and color of the TFT-LCD are deviated from the original image unless viewing at a central viewing angle. With foresaid image deviations, it is not applicable for users to view the TFT-LCD at large viewing angles. Among various display modes, the twisted nematic mode LCDs show the most significant limitations of the display performance in viewing angle.

To overcome the foresaid problems, the arrangement of the liquid crystal molecules in the liquid crystal display module are modified, and thus the techniques of multi-domain vertical alignment, MVA, and in-plane switching, IPS, are developed. Although the techniques are useful for increasing the viewing angle of the display, the process of the film transistor is required to be set before the production of the LCDs, such that said methods are still not suitable to flexibly overcome the problem of narrow viewing angle.

Therefore, there is still a need to effectively overcome the limitation in viewing angle without modifying the arrangements of the liquid crystal molecules in the LCD module.

### SUMMARY OF THE INVENTION

To overcome the drawbacks of narrow viewing angle of LCDs, the present invention provides a light redirecting film, comprising a transparent substrate and multiple microstructure units. The transparent substrate comprises a first optical surface and a second optical surface opposite the first optical surface, the microstructure units are formed on the second optical surface of the transparent substrate and spaced apart from each other, and the areal percentage of the second optical surface in contact with the microstructure units ranges from 8% to 60% based on a total area of the second optical surface.

Applying the light redirecting film to a liquid crystal display module redirects the light and distributes the light energy to different viewing angles without modifying arrangement of the liquid crystal molecules in the LCD module. Accordingly, the light redirecting film is effective to overcome the drawbacks of insufficient brightness and deficient display performance at large viewing angles, and thus avoids the limitation in viewing angle.

In application, the light redirecting film is useful to allow an LCD module with a viewing angle up to from 100° and 120°, and more preferably, with a wider viewing angle up to from 90° to 120°.

Preferably, the areal percentage of the second optical surface in contact with the microstructure units ranges from 10% to 60% based on the total area of the second optical surface; more preferably, said areal percentage ranges from 30% to 60%.

Preferably, each of the microstructure units is composed of multiple sub-microstructures. The sub-microstructures of one of the microstructure units are formed on the second optical surface and are spaced apart from each other or in contact with each other.

Preferably, each of the sub-microstructures has a depth ranging from 0.001 micrometers to 0.4 micrometers; more preferably, each of the sub-microstructures has a depth ranging from 0.005 micrometers to 0.4 micrometers.

For different visual angle demands of LCDs, each of the sub-microstructures may be, but not limited to, a prismatic sub-microstructure, an elliptic sub-microstructure, a freeform-shaped sub-microstructure, a semi-circular sub-microstructure, a trapezoid sub-microstructure, a complex sub-microstructure, or an irregular sub-microstructure.

Said “freeform-shaped sub-microstructure” is directed to a sub-microstructure formed by an aspherical and smooth curved surface. Said “complex sub-microstructure” is directed to a sub-microstructure formed in a combination of at least two different shapes selected from the group consisting of a prismatic shape, an elliptical shape, a trapezoid shape, a freeform shape, and a semi-circular shape. For example, the complex sub-microstructure may be a sub-microstructure formed in a combination of prismatic and semi-circular shapes or in a combination of elliptical and semi-circular shapes, but is not limited thereto.

Preferably, each of the prismatic sub-microstructures is formed on the second optical surface of the transparent substrate along an extending direction, and each of the prismatic sub-microstructures has a cross section formed in the shape of an isosceles triangle or non-isosceles triangle. Or, the top portion of each of the cross sections is formed in a circular, elliptical, or aspherical shape.

In one of the embodiments, each of the sub-microstructures extends along an extending direction, and the extending directions of the sub-microstructures are parallel with each other. That is, according to the X-axis and Y-axis of the second optical surface of the light redirecting film, an identical angle is formed between all of the extending directions and the X-axis, and another identical angle is formed between all of the extending directions and the Y-axis.

In another embodiment, each of the sub-microstructures extends along an extending direction, and the extending direction of one of the sub-microstructures intersects with the extending direction of another one of the sub-microstructures. For example, all extending directions may be classified into two groups, a first group and a second group. The extending directions of the first group are parallel with each other, and the extending directions of the second group are parallel with each other and intersect with the extending directions of the first group. That is, an identical angle is formed between the extending directions of the first group and the X-axis, and at least two different angles are respectively formed between the extending directions of the first group and the X-axis and between the extending directions of the second group and the X-axis. Similarly, an identical angle is formed between the extending directions of the first group and the Y-axis, and at least two different angles are respectively formed between the extending directions of the first group and the Y-axis and between the extending directions of the second group and the Y-axis.

Each of the prismatic sub-microstructures may have a peak formed in linear or non-linear formation. For example, each of the peaks of the prismatic sub-microstructures is waved continuously upward and downward along its extending direction with respect to the second optical surface as a horizontal reference plane. Or, each of the peaks of the prismatic sub-microstructures is waved continuously rightward and leftward along its extending direction on the basis of the normal plane of the second optical surface. Or, each of the peaks of the prismatic sub-microstructures is waved continuously both upward and downward along its extending direction with respect to the second optical surface as a horizontal reference plane and rightward and leftward along its extending direction on the basis of the normal plane of the second optical surface.

Preferably, a material of the transparent substrate may be polyethylene terephthalate (PET), polycarbonate (PC), polymethyl methacrylate (PMMA), polyimide (PI), polypropylene (PP), polystyrene (PS), methylmethacrylate-styrene copolymer (MS), or any of their combinations.

In accordance with the present invention, the light redirecting film may be fabricated by machining a roll mold with an ultrafine diamond tool and transfer-printing the roll mold with said pattern onto an original film. It is simple to produce the optical redirecting film of the present invention. By modifying the cutting angles of the ultrafine diamond tool moved on the roll mold, the fabricated light redirecting film can effectively distribute the light passing at different viewing angles, thereby optimizing the image brightness of the LCD.

Further, the present invention also provides a wide-viewing angle LCD, which comprises an LCD module and the light redirecting film as stated above. The LCD module comprises a light input surface and a light output surface opposite the light output surface, and the light redirecting film is disposed at the light output surface of the LCD module.

Preferably, the wide-viewing angle LCD comprises a bonding layer disposed between the light output surface of the LCD module and the light redirecting film.

The foresaid microstructure units are disposed between the transparent substrate of the light redirecting film and the LCD module. Or, the transparent substrate of the light redirecting film is disposed between the microstructure units of the light redirecting film and the LCD module.

Preferably, the LCD module has a periodic pixel pitch, and the microstructure units are spaced apart from each other at equal periodic intervals, which are non-proportional to the periodic pixel pitch. In another embodiment, the microstructure units are spaced apart from each other at various intervals different from the periodic pixel pitch, i.e., the microstructure units are spaced apart from each other in a random arrangement, so as to avoid Moiré fringes in wide-viewing angle LCDs.

Preferably, the area of the microstructure units of the LCD module in central viewing angle is smaller than the area of the pixels of the LCD module, so as to avoid Moiré fringes in wide-viewing angle LCDs.

Other objectives, advantages and novel features of the invention will become more apparent from the following detailed description when taken in conjunction with the accompanying drawings.

### BRIEF DESCRIPTION OF THE DRAWINGS

FIG. 1 is a top schematic view of a light redirecting film of Example 1;

FIG. 2A is an enlarged view of one of the microstructure units of the light redirecting film as shown in FIG. 1;

FIG. 2B is an end view of FIG. 2A;

FIG. 3 is a top schematic view of a light redirecting film of Example 2;

FIG. 4A is an enlarged end view of one of the microstructure unit of the light redirecting film as shown in FIG. 3;

FIG. 4B is an end view of one of the microstructure unit of the light redirecting film in another embodiment;

FIG. 4C is an end view of one of the microstructure unit of the light redirecting film in further another embodiment;

FIG. 5 is an end view of a light redirecting film of Example 3;

FIG. 6 is an end view of a light redirecting film of Example 4;

FIG. 7 is a top schematic view of a light redirecting film of Example 5;

FIG. 8A illustrates the optical field distributions of an original light source and a light source observed through the light redirecting film of Comparative Example 1, wherein the total areal percentage of the second optical surface in contact with the microstructure units is 5%;

FIG. 8B illustrates the optical field distributions of an original light source and a light source observed through the light redirecting film of Example 5, wherein the total areal percentage of the second optical surface in contact with the microstructure units is 8%;

FIG. 8C illustrates the optical field distributions of an original light source and a light source observed through the light redirecting film of Example 6, wherein the total areal percentage of the second optical surface in contact with the microstructure units is 30%;

FIG. 8D illustrates the optical field distributions of an original light source and a light source observed through the light redirecting film of Example 7, wherein the total areal percentage of the second optical surface in contact with the microstructure units is 60%;

FIG. 8E illustrates the optical field distributions of an original light source and a light source observed through the light redirecting film of Comparative Example 2, wherein the total areal percentage of the second optical surface in contact with the microstructure units is 65%.

### DETAILED DESCRIPTION OF THE PREFERRED EMBODIMENTS

### Example 1

### Light Redirecting Film

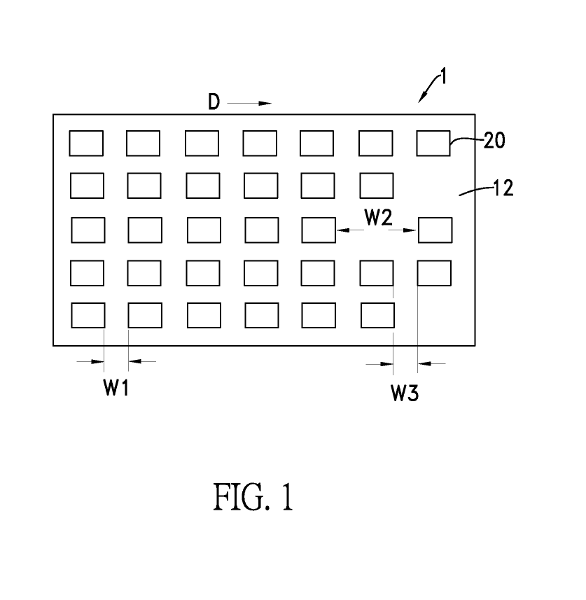

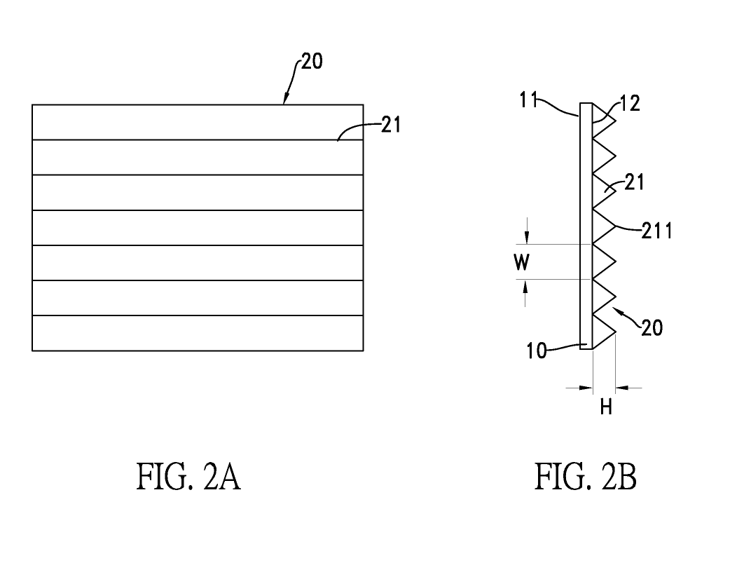

A representative example of a light redirecting film 1 of Example 1 in accordance with the present invention is illustrated in FIGS. 1, 2A, and 2B. The light redirecting film comprises a transparent substrate 10 and multiple microstructure units 20.

The transparent substrate 10 is a PET substrate having a light transmittance of 90%. The transparent substrate 10 has a first optical surface 11 and a second optical surface 12 opposite the first optical surface 11.

The microstructure units 20 are formed on the second optical surface 12 of the transparent substrate 10 and spaced apart from each other, and the percentage of the area of the second optical surface 12 in contact with the microstructure units 20 relative to the total area of the second optical surface 12 is 30%.

With reference to FIG. 1, in the left region of the light redirecting film 1, the microstructure units 20 have a fixed interval W1 between any two adjacent microstructure units 20. In the right region of the light redirecting film 1, the microstructure units 20 have an interval W2 between two adjacent microstructure units 20 and another interval W3 between another two adjacent microstructure units 20, and the interval W3 is different from the interval W2.

That is, a portion of the multiple microstructure units 20 are distributed on the left region of the second optical surface 12 at equal intervals, but the other portion of the microstructure units 20 are distributed on the right region of the second optical surface 12 at various intervals, rather than equal intervals.

In the instant example, each of the microstructure units 20 is composed of multiple prismatic sub-microstructures 21. Each of the prismatic sub-microstructures 21 is formed on the second optical surface 12 of the transparent substrate 10 along an extending direction D.

With reference to FIGS. 2A and 2B, the sub-microstructures 21 of one of the microstructure units 20 are formed on the second optical surface 12 of the transparent substrate 10 and in contact with each other. Peaks 211 of the sub-microstructures 21 are formed in a linear formation, and each of the cross-sections of the sub-microstructures 21 is formed in the shape of an isosceles triangle.

In the instant example, each of the sub-microstructure 21 has a depth H of 0.038 millimeters and a maximum width W of 0.04 millimeters. Because 30% of the second optical surface 12 is in contact with the microstructure units 20, the light redirecting film can redirect 30% of light output energy of an LCD module to the large viewing angles. Further, the size of each microstructure unit 20, less than 0.1 millimeters, is much smaller than the pixel size of the conventional LCD, and thus undesired image and interference caused by the microstructures can also be avoided by the use of the light redirecting film.

### Example 2

### Light Redirecting Film

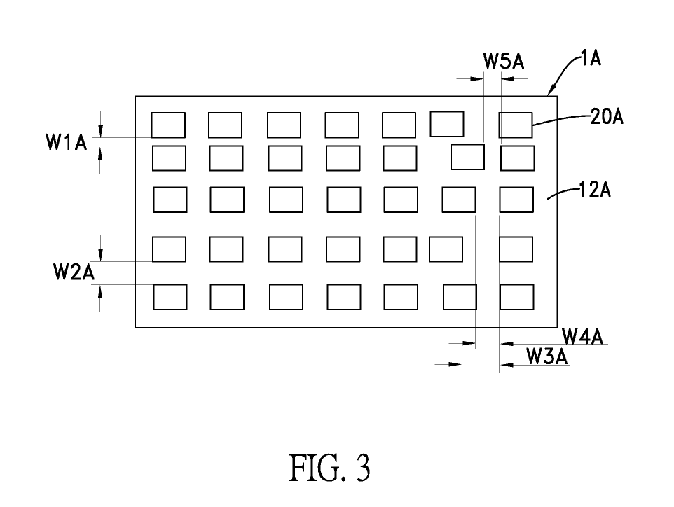

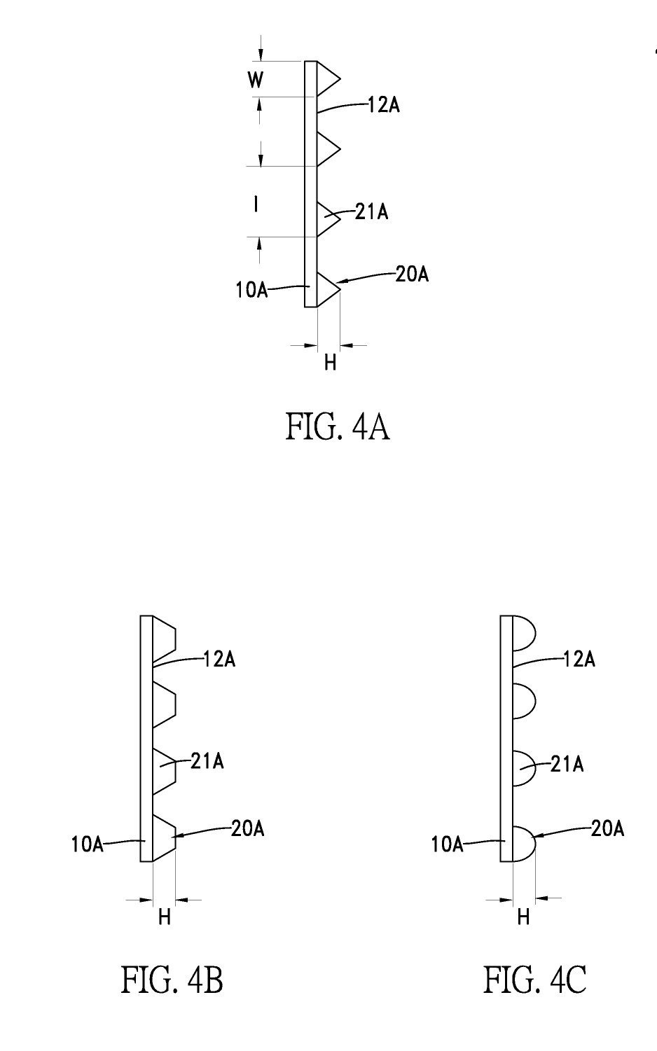

Another example of a light redirecting film 1A of Example 2 in accordance with the present invention is illustrated in FIGS. 3 and 4A. The light redirecting film 1A is similar with the light redirecting film of Example 1. The percentage of the area of the second optical surface 12A in contact with the microstructure units 20A relative to a total area of the second optical surface 12A is 30%. The prismatic sub-microstructures 21A are formed on the second optical surface 12A of the transparent substrate 10A and spaced apart from each other. The shape of the sub-microstructures 21A is not limited in prismatic shape. In another embodiment, the sub-microstructures 21A may be formed in trapezoid shape as shown in FIG. 4B; and in further another embodiment, the sub-microstructures 21A may be formed in freeform shape as shown in FIG. 4C.

With reference to FIG. 3, the microstructure units 20A have various intervals W1A between any two adjacent microstructure units 20A. In the left region of the light redirecting film 1A as shown in FIG. 3, the intervals W1A between two adjacent microstructure units 20A are gradually increased from one side of the light redirecting film 1A to the opposite side of the light redirecting film 1A. That is, the interval W2A is larger than the interval W1A. In the right region of the light redirecting film 1A as shown in FIG. 3, the microstructure units 20A are formed on the second optical surface 12A of the transparent substrate 10A and spaced apart from each other in a random arrangement, i.e., multiple different intervals W3A, W4A, W5A are formed between each two adjacent microstructure units 20A.

In the instant example, each of the sub-microstructures 21A has a fixed depth H of 0.038 millimeters and a fixed maximum width W of 0.04 millimeters, and any two adjacent sub-microstructures have a fixed interval I of 0.065 millimeters. In another or further another embodiments, the trapezoid and freeform-shaped sub-microstructures 21A have a fixed depth H of 0.038 millimeters as shown in FIGS. 4B and 4C.

The differences between the instant example and Example 1 are that the intervals between two adjacent microstructure units 20A of the instant example are varied within a specific range, and all sub-microstructures 21A of the instant example have the identical depth and identical width and are spaced apart from each other at the equal intervals. Accordingly, the microstructure units 20A of the light redirecting film 1A hardly have an interval equal to or in a multiple relation with the pixel pitch of an LCD module, and thus the light redirecting film is also beneficial for avoiding the periodic interference of a wide-viewing angle LCD.

### Example 3

### Wide-Viewing Angle LCD

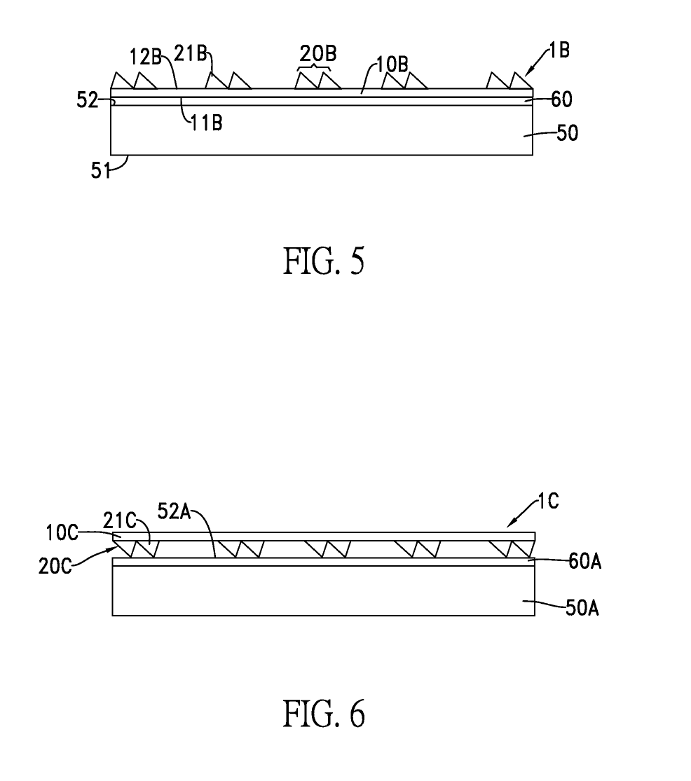

A representative example of a wide-viewing angle LCD of Example 3 in accordance with the present invention is illustrated in FIG. 5. The wide-viewing angle LCD comprises a light redirecting film 1B, an LCD module 50, and a bonding layer 60.

In the instant example, the light redirecting film 1B is similar with that of Example 2 except that two adjacent and contacting sub-microstructures 21B are spaced apart from another two adjacent and contacting sub-microstructures 21B and are formed on the second optical surface 12B of the transparent substrate 10B, and each of the cross-sections of the sub-microstructures 21B is formed in the shape of an nonisosceles triangle.

The LCD module 50 has a light input surface 51 and a light output surface 52 opposite the light input surface 51. The bonding layer 60 is disposed at the light output surface 52, so as to adhere to the first optical surface 11B of the light redirecting film 1B and the light output surface 52 of the LCD module 50.

In the instant example, each of the sub-microstructures 21B of the light redirecting film 1B has a depth of 0.038 millimeters and a maximum width of 0.04 millimeters, and any two adjacent sub-microstructures 21B have an interval of 0.07 millimeters between them. The size of the microstructure unit 20B composed of two adjacent and contacting sub-microstructures 21B is smaller than the pixel size of the conventional LCD, which is about 0.2 millimeters to 0.4 millimeters, thereby avoiding undesired image and interference typically occurring on the wide-viewing angle LCD.

### Example 4

### Wide-Viewing Angle LCD

Another representative example of a wide-viewing angle LCD of Example 4 in accordance with the present invention is illustrated in FIG. 6. The wide-viewing angle LCD is similar with that of Example 3 except that the microstructure units 20C is facing to the LCD module. More specifically, the microstructure units 20C of the light redirecting film 1C is disposed between the transparent substrate 10C and the LCD module 50A, and the microstructure units 20C of the light redirecting film 1C is adhered onto the light output surface 52A of the LCD module 50A by the bonding layer 60A.

For improving the stability of the microstructure unit 20C and the LCD module 50A, an adhesive gel with low refractive index is also filled into the space between the transparent substrate 10C and the bonding layer 60A to ensure the light redirecting film 1C is stably fixed onto the LCD module 50A.

As described in Example 3, each of the sub-microstructures 21C of the light redirecting film 1C of the instant Example has a depth of 0.038 millimeters and a maximum width of 0.04 millimeters, and any two adjacent sub-microstructures 21C have an interval of 0.07 millimeters between them. The size of the microstructure unit 20C composed of two adjacent and contacting sub-microstructures 21C is smaller than the pixel size of the conventional LCD, thereby avoiding undesired image and interference typically occurring on the wide-viewing angle LCD.

### Example 5

### Light Redirecting Film

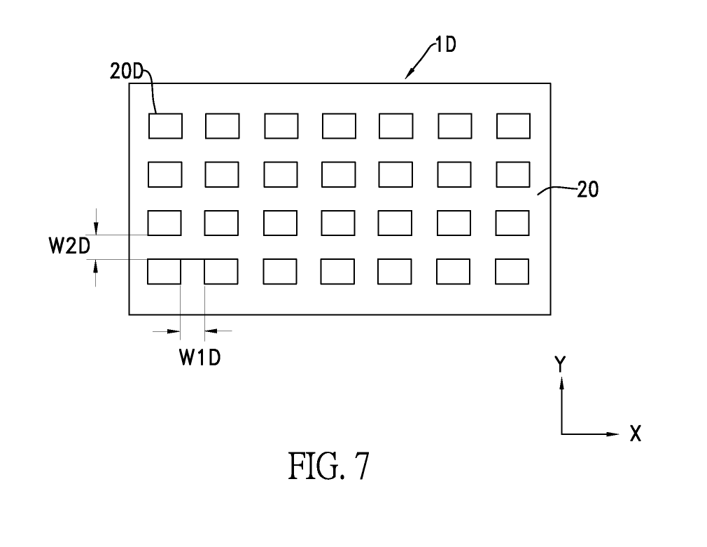

With reference to FIG. 7, the light redirecting film 1D of Example 5 is similar with that of Example 2 except that the microstructure units 20D are formed on the second optical surface 12D and spaced apart from each other at equal intervals and the percentage of the area of the second optical surface 12D in contact with the microstructure units 20D relative to a total area of the second optical surface 12D is 8%.

In the whole region of the light redirecting film 1D, the microstructure units 20D have a fixed first interval W1D between any two adjacent microstructure units 20D along the X direction of the light redirecting film 1D and a fixed second interval W2D between any two adjacent microstructure units 20D along the Y direction of the light redirecting film 1D. That is, the microstructure units 20D are formed on the second optical surface 12D in a regular array arrangement.

In the instant example, each of the sub-microstructures has a depth of 0.038 millimeters and a maximum width of 0.04 millimeters, and any two adjacent sub-microstructures have an interval of 0.065 millimeters between them.

### Example 6

### Light Redirecting Film

The light redirecting film of Example 6 is similar with that of Example 5 except that the percentage of area of the second optical surface in contact with the microstructure units relative to the total area of the second optical surface is 30%.

### Example 7

### Light Redirecting Film

The light redirecting film of Example 7 is similar with that of Example 5 except that the percentage of the area of the second optical surface in contact with the microstructure units relative to the total area of the second optical surface is 60%.

### Comparative Example 1

### Light Redirecting Film

The light redirecting film of Comparative Example 1 is similar with that of Example 5 except that the percentage of the area of the second optical surface in contact with the microstructure units relative to the total area of the second optical surface is 5%.

### Comparative Example 2

### Light Redirecting Film

The light redirecting film of Comparative Example 2 is similar with that of Example 5 except that the percentage of the area of the second optical surface in contact with the microstructure units relative to the total area of the second optical surface is 65%.

### Test Example 1

In Test Example 1, the light redirecting films of Examples 5 to 7 and Comparative Examples 1 and 2 were used to observe the distribution of the light energy under the same light source, so as to assess the light redirecting effect of the light redirecting films.

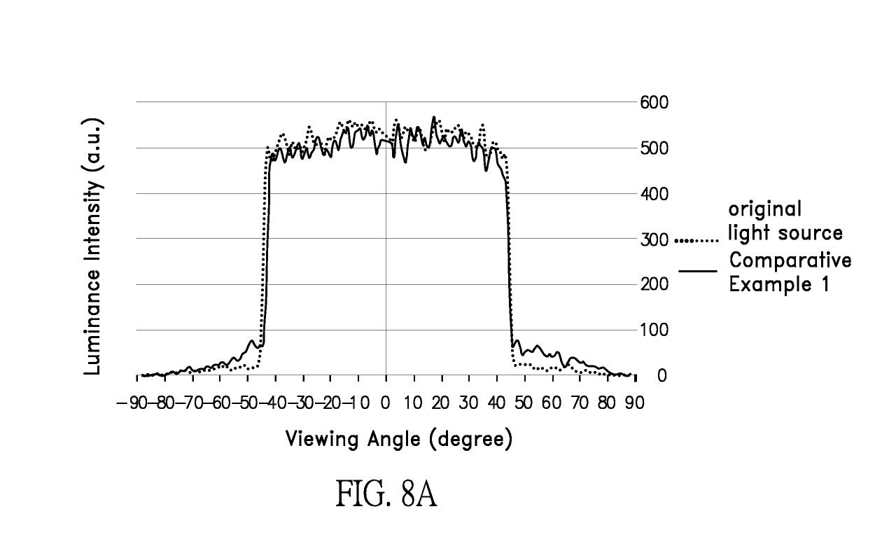

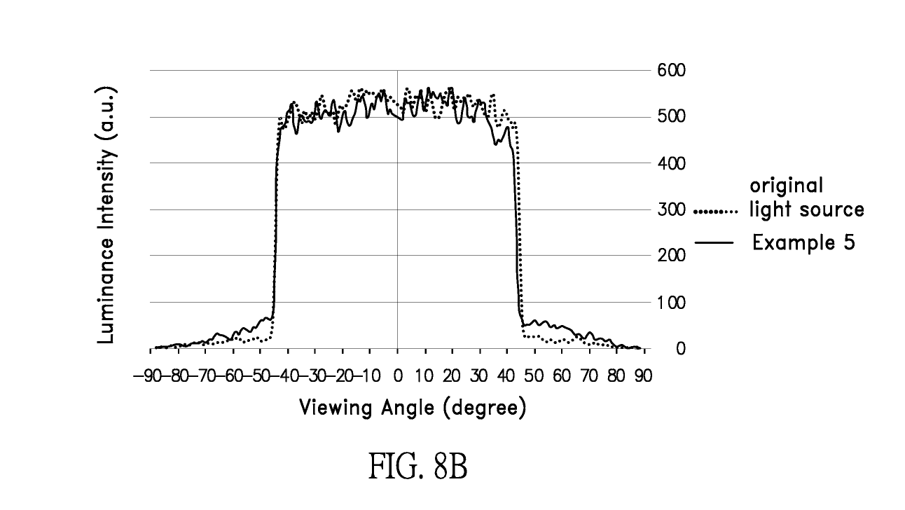

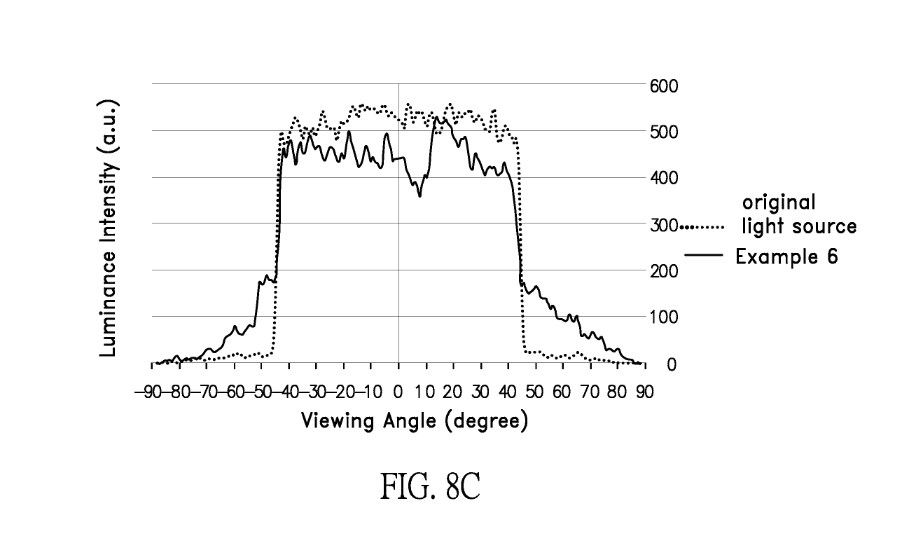

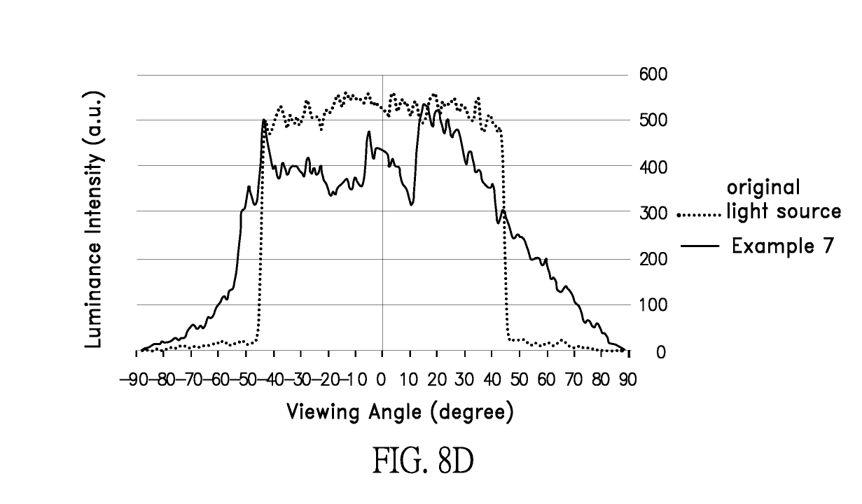

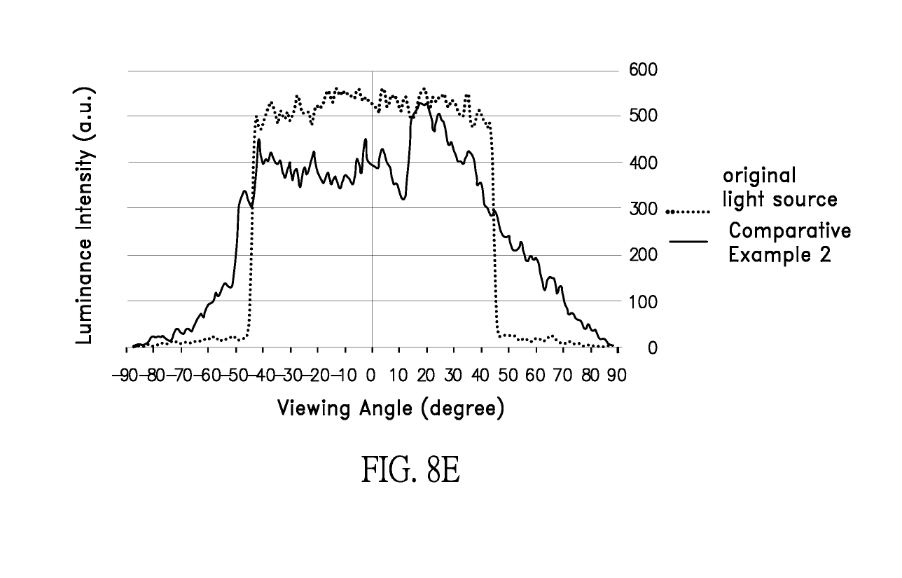

With reference to FIGS. 8A to 8E, when the percentage of the area of the second optical surface in contact with the microstructure units relative to the total area of the second optical surface increases, the light energy distribution at large viewing angles also increases, indicating that the light redirecting film of the present invention is useful for redirecting the output light of the LCD module to the outer region, also called the region around large viewing angles, so as to enhance the light energy around the outer region.

With reference to FIG. 8A, when the percentage of the area of the second optical surface in contact with the microstructure units relative to the total area of the second optical surface is 5%, the luminance intensity at large viewing angle, i.e., a viewing angle larger than 50 degrees, is as low as that of original light source, showing that the light redirecting film of Comparative Example 1 cannot provide a desired light redirecting effect when applied to LCD. With reference to FIG. 8E, when the percentage of the area of the second optical surface in contact with the microstructure units relative to the total area of the second optical surface is 65%, the light intensity at small viewing angle, i.e., a viewing angle around 0 degree, is decreased by more than 20%, showing that the visual effect of LCD at small viewing angle is largely deteriorated by using the light redirecting film of Comparative Example 2.

### Test Example 2

To determine the effect of the light redirecting film for a conventional twisted nematic LCD, a hand-held luminance meter was used to measure the value of the luminance of the twisted nematic LCD of a notebook at a viewing angle of 140 degrees with or without using the light redirecting film.

When measuring at a viewing angle of 140 degrees, the luminance of the twisted nematic LCD attached with the light redirecting film on its light output surface is 4.02 nits, and the luminance of the twisted nematic LCD without the light redirecting film is 1.68 nits. Thus, the light redirecting film not only improves the visual effect at large viewing angles but also enhances the luminance at large viewing angles about three folds compared to the original twisted nematic LCD.

The visual effects of the LCD at downward viewing angles with or without the light redirecting film were also observed. When observing the original LCD, the gray-scale inversion still existed at downward viewing angles. However, when observing the LCD with the light redirecting film of Example 6 at the same viewing angle, the problem of gray-scale inversion had been effectively overcome, such that the viewer could clearly observe an image and brightness at the large viewing angles similar with those observed at central viewing angle.

Moreover, the visual effects of the LCD at central viewing angle with or without the light redirecting film were also observed. When observing the LCDs with or without the light redirecting film of Example 6 at central viewing angle, the brightness of the center image of the LCD with the light redirecting film was only slightly lower than that of the center image of the LCD without the light redirecting film.

In summary, by controlling the areal percentage of the second optical surface in contact with the microstructure units, the light redirecting film of the present invention not only maintains the display performance of the LCD at central viewing angle, but also effectively overcomes the gray-scale inversion of the TN-LCD when observing at large viewing angles.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A light redirecting film, comprising a transparent substrate and multiple microstructure units, the transparent substrate comprising a first optical surface and a second optical surface opposite the first optical surface, the microstructure units formed on the second optical surface of the transparent substrate and spaced apart from each other, wherein an areal percentage of the second optical surface in contact with the microstructure units ranges from 8% to 60% based on a total area of the second optical surface.

2. The light redirecting film as claimed in claim 1, wherein each of the microstructure units is composed of multiple sub-microstructures, and the sub-microstructures of one of the microstructure units are formed on the second optical surface and in contact with each other.

3. The light redirecting film as claimed in claim 1, wherein each of the microstructure units is composed of multiple sub-microstructures, and the sub-microstructures of one of the microstructure units are formed on the second optical surface and spaced apart from each other.

4. The light redirecting film as claimed in claim 2, wherein the sub-microstructures of each microstructure unit are prismatic sub-microstructures.

5. The light redirecting film as claimed in claim 4, wherein each of the prismatic sub-microstructures has a cross section formed in shape of an isosceles triangle or a non-isosceles triangle.

6. The light redirecting film as claimed in claim 5, wherein the prismatic sub-microstructures are formed on the second optical surface of the transparent substrate along an extending direction, and the extending directions of the sub-microstructures are parallel with each other.

7. The light redirecting film as claimed in claim 4, wherein each of the prismatic sub-microstructures has a peak formed in linear formation.

8. The light redirecting film as claimed in claim 1, wherein the transparent substrate is made of a material selected from the group consisted of polyethylene terephthalate, polycarbonate, polymethyl methacrylate, polyimide, polypropylene, polystyrene, methylmethacrylate-styrene copolymer, and any of their combinations.

9. A wide-viewing angle liquid crystal display, having a liquid crystal display module and a light redirecting film as claimed in claim 1, wherein the liquid crystal display module comprises a light input surface and a light output surface opposite the light input surface, and the light redirecting film is disposed at the light output surface of the liquid crystal display module.

10. The wide-viewing angle liquid crystal display as claimed in claim 9, wherein the transparent substrate is disposed between the microstructure units and the liquid crystal display module.

11. The wide-viewing angle liquid crystal display as claimed in claim 9, wherein the microstructure units are disposed between the transparent substrate and the liquid crystal display module.

12. The wide-viewing angle liquid crystal display as claimed in claim 9, wherein the liquid crystal display module has a periodic pixel pitch, the microstructure units are spaced apart from each other at equal periodic intervals, and the periodic intervals are non-proportional to the periodic pixel pitch.

13. The wide-viewing angle liquid crystal display as claimed in claim 9, wherein the liquid crystal display module has a periodic pixel pitch, and the microstructure units are spaced apart from each other at various intervals, and the intervals are different from the periodic pixel pitch.

14. The wide-viewing angle liquid crystal display as claimed in claim 9, wherein the wide-viewing angle liquid crystal display further has a bonding layer disposed between the light output surface and the light redirecting film.
